(19) United States
(12) Patent Application Publication
(10) Pub. No.: US 2016/0360393 A1
(43) Pub. Date: Dec. 8, 2016

(54) Method, Apparatus and System for Sending Device Discovery Signal

(71) Applicant: ZTE Corporation, Shenzhen (CN)

(72) Inventors: Shuanshuan WU, Shenzhen (CN); Jin YANG, Shenzhen (CN); Shuanghong HUANG, Shenzhen (CN)

(73) Assignee: ZTE Corporation, Shenzhen (CN)

(21) Appl. No.: 15/114,645

(22) PCT Filed: Oct. 23, 2014
(86) PCT No.: PCT/CN2014/089229

§ 371 Date: Jul. 27, 2016

(30) Foreign Application Priority Data
Jan. 27, 2014 (CN) 201410040548.9

(51) Int. Cl. H04W 8/00; H04L 5/00; H04W 72/04

(52) U.S. Cl. CPC H04W 8/005; H04W 72/042; H04W 72/048; H04L 5/0007

(57) ABSTRACT

Provided are a method, apparatus and system for sending a device discovery signal. The sending method includes that: a first User Equipment (UE) receives a device discovery resource configuration message, and determines, according to the device discovery resource configuration message, a device discovery resource for transmitting a device discovery signal; the first UE generates a device discovery signal, wherein the device discovery signal includes a message portion and a sequence portion, the message portion is used for bearing information about the first UE which needs to be interacted in a device discovery process of Device-to-Device (D2D) communication, and the sequence portion is used for implementing demodulation of the device discovery signal or synchronization in the device discovery process; and the first UE sends the device discovery signal in the device discovery resource.

### TECHNICAL FIELD

The present disclosure relates to the field of communications, and in particular to a method, apparatus and system for sending a device discovery signal.

### BACKGROUND

In a cellular communication system, when service transmission is conducted between two pieces of User Equipment (UE), for instance, when service data transmission from a UE1 to a UE2 is conducted, service data is transmitted to a base station (the term “base station” is used hereinafter to represent base station, or Node B, or evolved Node B) of a cell where the UE1 is located via an air interface; the base station transmits the service data from the user to a base station of a cell where the UE2 is located via a core network, and the base station of the cell where the UE2 is located transmits the service data to the UE2 via an air interface. The service data transmission from the UE2 to the UE1 adopts a similar processing flow. As shown in FIG. 1a, when the UE1 and the UE2 are located in an identical cell, although the two UEs are covered by the cell of an identical base station, the data still needs to be transferred via the core network during the data transmission, and radio spectrum resources on two links will still be consumed in single data transmission.

Thus it can be seen that if the UE1 and the UE2 are located in the identical cell and in proximity to each other, the above cellular communication method is not optimal obviously. Actually, as mobile communication services are diversified, for example, with the popularization of the application of a social network, an electronic payment application etc. to a wireless communication system, the demand for service transmission between proximity users is increasing. Consequently, a Device-to-Device (D2D) communication mode has been more and more widely concerned. As shown in FIG. 1b, D2D, which can be also called Proximity Service (ProSe), refers to direct transmission of the service data from a source UE to a target UE via an air interface without forwarding the service data via the base station and the core network. For users in near field communication, D2D saves the radio spectrum resources and reduces the data transmission burden to the core network.

In cellular communication, when two UEs communicate with each other, a UE will not know the position of an opposite UE under general conditions, and the connection between the two UEs is established via a network side device such as a base station or a core network device. For D2D communication, the precondition of establishing a communication link is mutual discovery between UEs, namely determination of a proximity relationship between the UEs. One of the manners for implementing device discovery is completed by sending and detecting a device discovery signal. However, in an actual system, the device discovery signal and a cellular communication signal probably co-exist, device discovery signals sent by different UEs probably co-exist, these signals probably interfere with one another, and therefore the device discovery efficiency is influenced.

An effective solution is not proposed currently for the problem in the relevant art that device discovery signals interfere with one another so as to influence the device discovery efficiency.

### SUMMARY

The embodiments of the present disclosure provide a method, apparatus and system for sending a device discovery signal, which are intended to at least solve the problem in the relevant art that device discovery signals interfere with one another.

According to one embodiment of the present disclosure, a method for sending a device discovery signal is provided, which may include that: a first UE receives a device discovery resource configuration message, and determines, according to the device discovery resource configuration message, a device discovery resource for transmitting a device discovery signal; the first UE generates a device discovery signal, wherein the device discovery signal includes a message portion and a sequence portion, the message portion is used for bearing information about the first UE which needs to be interacted in a device discovery process of D2D communication, and the sequence portion is used for implementing demodulation of the device discovery signal or synchronization in the device discovery process; and the first UE sends the device discovery signal in the device discovery resource.

In an exemplary embodiment, the sequence portion may include at least one of a Zadoff-Chu (ZC) sequence, a Quadrature Phase Shift Keying (QPSK) modulation symbol sequence and an m-sequence. And/or, generating a baseband signal of a physical channel corresponding to the message portion may include: scrambling a bit content of the message portion by using a scrambling sequence of which a length is equal to the number of bits in the bit content transmitted by the message portion; performing modulation mapper on the scrambled message portion; performing transform precoder on a modulation symbol sequence obtained by the modulation mapper; performing Resource Element (RE) mapper on a sequence obtained by the transform precoder; and generating a Single Carrier-Frequency Division Multiplexing Access (SC-FDMA) signal based on a signal obtained by the RE mapper.

In an exemplary embodiment, an initialization sequence of the scrambling sequence may be determined by at least one of the following parameters: a discovery area Identity (ID), a cell ID, a cycle index, a scrambling ID, an ID of the first UE, a resource index and an ID of a sequence of the sequence portion.

In an exemplary embodiment, the cycle index may include: a cycle index of the device discovery resource or a cycle index for sending the device discovery signal.

In an exemplary embodiment, the discovery area ID may be used for indicating a pre-determined discovery area, wherein the discovery area may include one of: a plurality of cells having a same device discovery resource configuration; one Track Area (TA) or cells having a same frequency point in one TA; one or multiple cells covered by a base station or cells having a same frequency point in the cells; one macro base station cell and affiliated small cells; cells having a same frequency point in one macro base station cell and affiliated small cells; and one Multicast Broadcast Single Frequency Network (MBSFN) area.

In an exemplary embodiment, the scrambling ID may be determined by one of: indication from control signalling sent by a network side; calculation conducted by the first UE in accordance with an appointed rule; and random selection conducted by the first UE from a pre-determined scrambling ID set.

In an exemplary embodiment, the ID of the first UE may include one of: a Radio Network Temporary Indicator (RNTI) or information obtained by calculation according to the RNTI; an International Mobile Subscriber Identity (IMSI) or information obtained by calculation according to the IMSI; a Temporary Mobile Subscriber Identity (TMSI) or information obtained by calculation according to the TMSI; and a ProSe ID or a D2D communication ID.

In an exemplary embodiment, the resource index may include: a time domain resource index and/or a frequency domain resource index, wherein the frequency domain resource index is determined according to a frequency domain resource position of the device discovery signal, the time domain resource index is determined according to a time domain resource position of the device discovery signal, and a time domain position is indicated by an index of a sub-frame for sending the device discovery signal in a radio frame or indicated by an index of a sub-frame for sending the device discovery signal within a discovery resource cycle.

In an exemplary embodiment, the ID of the sequence may be determined by one of: a sequence index of the sequence; a cyclic shift value of the sequence; and the sequence index of the sequence and the cyclic shift value of the sequence.

In an exemplary embodiment, an initialization parameter of the scrambling sequence in a synchronous network deployment may be different from an initialization parameter of the scrambling sequence in a non-synchronous network deployment.

In an exemplary embodiment, the sequence of the sequence portion may be a cyclic shift of a base sequence or a cyclic shift of a root sequence. A cyclic shift value may be determined by one of: indication from control signalling sent by the network side; calculation conducted by the first UE in accordance with an appointed rule; and random selection conducted by the first UE from a pre-determined cyclic shift value set.

In an exemplary embodiment, after the first UE sends the device discovery signal in the device discovery resource, the method may further include that: a second UE detects the device discovery signal and discovers the first UE through the device discovery signal.

According to another embodiment of the present disclosure, an apparatus for sending a device discovery signal is provided, which may include: a first communication element, configured to receive a device discovery resource configuration message, and determine, according to the device discovery resource configuration message, a device discovery resource for transmitting a device discovery signal; a baseband processing element, configured to generate the device discovery signal, wherein the device discovery signal includes a message portion and a sequence portion, the message portion is used for bearing information about a first UE which needs to be interacted in a device discovery process of D2D communication, and the sequence portion is used for implementing demodulation of the device discovery signal or synchronization in the device discovery process; and a second communication element, configured to send the device discovery signal in the device discovery resource.

In an exemplary embodiment, the baseband processing element may be configured to generate a baseband signal of a physical channel corresponding to the message portion in a following manner: scrambling a bit content of the message portion by using a scrambling sequence of which a length is equal to the number of bits in the bit content transmitted by the message portion; performing modulation mapper on the scrambled message portion; performing transform precoder on a modulation symbol sequence obtained by the modulation mapper; performing RE mapper on a sequence obtained by the transform precoder; and generating an SC-FDMA signal based on a signal obtained by the RE mapper.

In an exemplary embodiment, an initialization sequence of the scrambling sequence may be determined by at least one of the following parameters: a discovery area ID, a cell ID, a cycle index, a scrambling ID, an ID of the first UE, a resource index and an ID of a sequence of the sequence portion.

According to another embodiment of the present disclosure, a wireless communication system is provided, which may include: a network side device, a first UE and a second UE. The network side device may include: a configuration component, configured to configure a device discovery resource for D2D communication; and a sending component, configured to send a device discovery resource configuration message, wherein the device discovery resource configuration message carries the device discovery resource. The first UE may include: a first communication element, configured to receive the device discovery resource configuration message, and determine, according to the device discovery resource configuration message, the device discovery resource for transmitting a device discovery signal; a baseband processing element, configured to generate the device discovery signal; and a second communication element, configured to send the device discovery signal in the device discovery resource. The second UE may be configured to detect the device discovery signal and discover the first UE through the device discovery signal.

In an exemplary embodiment, the network side device may include at least one of: a base station, a network access device other than the base station, an upper network node, a server or a network element providing service for the D2D communication, a network element temporarily deployed in a no coverage scenario, and a UE serving as a cluster head or a primary UE.

By means of the embodiments of the present disclosure, a UE acquires a device discovery resource for transmitting a device discovery signal from a device discovery resource configuration message, and transmits the device discovery signal on the device discovery resource, thereby solving the problems about signal processing and sending of the device discovery signal during the D2D communication, effectively avoiding interferences between discovery signals sent by different UEs and improving the universality and efficiency of a device discovery method and apparatus.

### BRIEF DESCRIPTION OF THE DRAWINGS

The drawings described here are intended to provide further understanding of the present disclosure, and form a part of the present disclosure. The schematic embodiments and descriptions of the present disclosure are intended to explain the present disclosure, and do not form improper limits to the present disclosure. In the drawings:

FIG. 1a is a diagram of cellular communication between UEs located in an identical cell of the base station according to the relevant art;

FIG. 1b is a diagram of D2D communication in an identical cell of the base station according to the relevant art;

FIG. 2 is a diagram of a radio resource structure in the relevant art;

FIG. 3 is a diagram of a cellular network deployment in the relevant art;

FIG. 4 is a structural diagram of a wireless communication system according to an embodiment of the present disclosure;

FIG. 5 is a structural diagram of a network side device according to an embodiment of the present disclosure;

FIG. 6 is a structural diagram of an apparatus for sending a device discovery signal according to an embodiment of the present disclosure; and

FIG. 7 is a flowchart of a method for sending a device discovery signal according to an embodiment of the present disclosure.

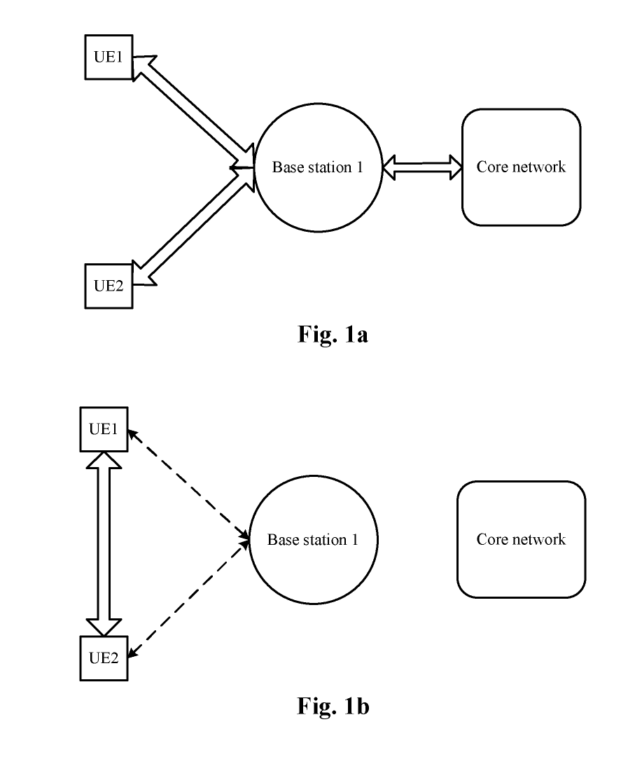

### DETAILED DESCRIPTION OF THE EMBODIMENTS

The present disclosure is described below with reference to the drawings and the embodiments in detail. It is important to note that the embodiments of the present disclosure and the characteristics in the embodiments can be combined mutually under the condition of no conflicts.

The technical solutions provided by the embodiments of the present disclosure are applied to cellular wireless communication systems or networks. Common cellular wireless communication systems may be based on a Code Division Multiplexing Access (CDMA) technology, a Frequency Division Multiplexing Access (FDMA) technology, an Orthogonal-FDMA (OFDMA) technology, an SC-FDMA technology and the like. For example, a downlink (or called a forward link) of a 3^{rd} Generation Partnership Project (3GPP) Long Term Evolution (LTE)/LTE-Advanced (LTE-A) cellular communication system is based on the OFDMA technology, and an uplink (or called a reverse link) is based on the SC-FDMA technology. A mixed multiple access technology will be probably supported on a link in the future.

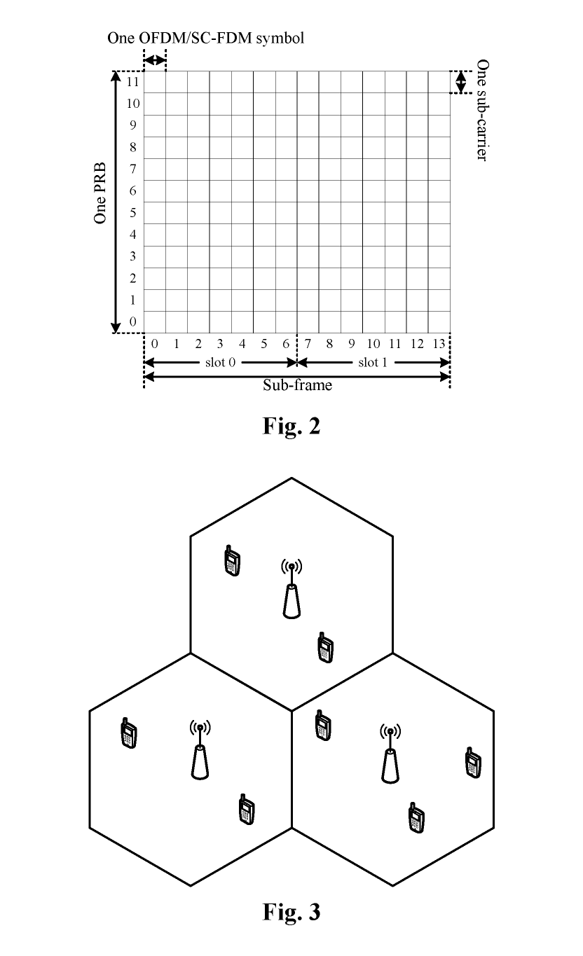

In an OFDMA/SC-FDMA system, radio resources for communication are in a two-dimensional time-frequency form. For example, for an LTE/LTE-A system, communication resources of an uplink and a downlink are divided in radio frames in a time direction. As shown in FIG. 2, each radio frame is 10 ms in length and includes 10 sub-frames which are 1 ms in length, each sub-frame including two slots which are 0.5 ms in length. According to different configurations of a Cyclic Prefix (CP), each slot may include 6 or 7 OFDM or SC-FDM symbols.

In a frequency direction, resources are divided in subcarriers. Specifically in communication, the minimum allocation unit of frequency domain resources is one Resource Block (RB) corresponding to one Physical RB (PRB) of physical resources. One PRB contains 12 sub-carriers in a frequency domain corresponding to one slot in a time domain. As shown in FIG. 2, the resource corresponding to one sub-carrier on each OFDM or SC-FDM symbol is called an RE.

It is important to note that in D2D discovery, in view of the speciality of a D2D scenario, resource structures may be partially different. For example, in D2D discovery sub-frames, available OFDM or SC-FDM symbols may not be illustrated values. For example, the first one or more symbols of the first slot in the D2D discovery sub-frames and/or the last one or more symbols of the second slot may be unavailable for discovery signal transmission.

In LTE/LTE-A cellular communication, a UE discovers an LTE network by detecting a Synchronization Signal (SS), the SS including a Primary SS (PSS) and a Secondary SS (SSS). By detecting the SS, the UE keeps synchronous with a base station in downlink frequency and time domain. Moreover, since the SS carries a physical cell ID, detection of the SS also enables discovery of an LTE/LTE-A cell by the UE.

When the UE transmits uplink data on an uplink, the UE should initiate a Random Access (RA) to perform uplink synchronization and establish Radio Resource Control (RRC) connection, namely switch from an RRC idle state to an RRC connected state. During the RA, the UE should send an RA preamble, and a network side detects the RA preamble in a specific time frequency resource, thereby realizing recognition of the UE and synchronization of the uplink.

During D2D communication, similar demands for mutual discovery between communication devices also exist. Namely, UEs for D2D communication firstly need to realize mutual discovery to confirm that the UEs are in proximity to each other. In the embodiments of the present disclosure, the discovery is called D2D communication discovery or D2D discovery or device discovery. In the embodiments of the present disclosure, the device discovery is realized by transmitting and detecting a device discovery signal between the UEs. In an implementation mode described by the embodiments of the present disclosure, the device discovery signal at least includes a message portion and a sequence portion.

FIG. 3 shows a diagram of a network deployment of a cellular wireless communication system. A 3GPP LTE/LTE-A system or other cellular wireless communication technologies can be shown in FIG. 3. In an access network of the cellular wireless communication system, a network device generally includes a certain number of base stations and other network entities or network elements, wherein the base station may also be called a Node B or an evolved Node B (eNB) or an enhanced Node B (eNB). Or, broadly speaking, in a 3GPP, they can be collectively known as an Evolved Universal Terrestrial Radio Access Network (E-UTRAN). The base stations described may here also include a Low Power Node (LPN) in the network, such as a pico, a relay, a femto and a Home eNB (HeNB), which can be collectively known as a small cell. Compared with the small cell, a traditional base station may be called a macro eNB. In order to simplify descriptions, FIG. 3 only shows three base stations. A base station can provides a certain radio signal coverage range, and a terminal or a UE or a device within the coverage range can wirelessly communicate with the base station. A radio signal coverage area of a base station may be divided into one or more cells (for example, three cells) or sectors on the basis of certain criteria.

D2D discovery discussed in a current 3GPP includes two main scenarios, namely an intra-cell discovery scenario and an inter-cell discovery scenario. The intra-cell discovery refers to that transmitter and receiver UEs of the device discovery signals reside in an identical cell, namely discovery of UEs of the local cell. The inter-cell discovery refers to that transmitter and receiver UEs of the the device discovery signals reside in different cells, namely discovery of UEs of other cells.

### Embodiment 1

According to the embodiment of the present disclosure, a wireless communication system is provided. The system can realize device discovery during D2D communication in a cellular communication system.

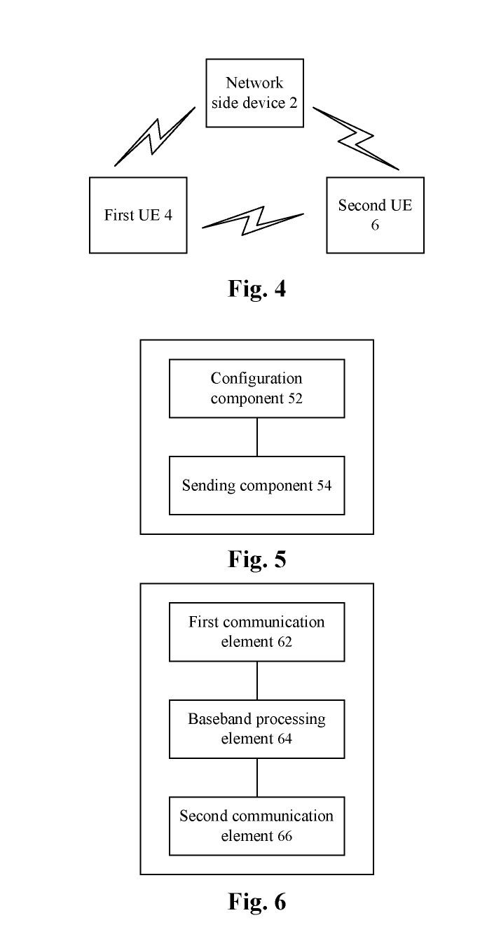

FIG. 4 is a structural diagram of a wireless communication system according to an embodiment of the present disclosure. As shown in FIG. 4, the wireless communication system according to the embodiment of the present disclosure includes: a network side device 2, a first UE 4 and a second UE 6. Each entity is described below. The network side device 2 can be located in a cellular network.

In one embodiment, the network side device 2 in the cellular network may be used for configuring a device discovery resource. For example, as shown in FIG. 5, the network side device may, at least, include: a configuration component 52, at least configured to configure a device discovery radio resource for D2D communication and generate a corresponding device discovery resource configuration message; and a sending component 54, configured to send the device discovery resource configuration message, wherein the configuration message carries a D2D device discovery configuration parameter for indicating a radio resource for device discovery. For example, the device discovery resource may be configured in a cyclic mode, the device discovery radio resource in each cycle is divided into discovery REs in a time division multiplexing mode and/or a frequency division multiplexing mode, and each discovery signal may be transmitted on one discovery RE. The time length of each discovery RE may be determined in a unit of sub-frame. For example, the time length of a discovery RE may be 1 or 2 sub-frames. The frequency bandwidth of each discovery RE may be determined in a unit of RB. For example, the time length of a discovery RE may be 1 or 2 RBs.

In one implementation mode, the network side device 2 may be a base station or an eNB or other network access devices such as a small cell, or may be an upper network node such as a gateway or a Mobility Management Entity (MME) or other servers (for example, a ProSe server) or network elements providing service for D2D, or simultaneously includes one or more of the above mentioned nodes.

In one implementation mode, the network side device 2 may be a network element temporarily deployed in a no coverage scenario. The no coverage scenario refers to a scenario where a UE is located in a blind coverage area of a cellular network, for example, a scenario of existence of cellular infrastructure damage or coverage hole.

In one implementation mode, the network side device 2 may be a UE serving as a cluster head or a primary UE. For example, in some specific scenarios such as a no network coverage scenario, a specific UE may configure a device discovery resource.

In one embodiment, the first UE 4 may include an apparatus for sending a device discovery signal as shown in FIG. 6. As shown in FIG. 6, the apparatus for sending a device discovery signal in the first UE 4 may, at least, include: a first communication element 62, a baseband processing element 64 and a second communication element 66.

The first communication element 62 is at least configured to receive a device discovery resource configuration message from a network node, wherein the device discovery resource configuration message is at least used for indicating a radio resource for device discovery. Optionally, the radio resource for device discovery is provided according to a certain cycle, and a device discovery radio resource in each discovery resource cycle is divided into discovery REs in a time division multiplexing mode and/or a frequency division multiplexing mode.

The baseband processing element 64 is at least configured to process a device discovery signal, namely generate the device discovery signal. Optionally, in the embodiment of the present disclosure, the device discovery signal may include a message portion and a sequence portion, wherein the message portion is used for bearing information about the first UE which needs to be interacted in a device discovery process of D2D communication, and the sequence portion is used for implementing demodulation of the device discovery signal or synchronization in the device discovery process. Optionally, the baseband processing element 64 may generate a baseband signal of a physical channel corresponding to the message portion in accordance with the following steps: scrambling, modulation mapper, transform precoder, RE mapper and SC-FDMA signal generation. The baseband processing element 64 may generate the sequence portion in accordance with at least one of the following sequence modes: a ZC sequence, a QPSK modulation symbol sequence and an m-sequence. It is important to note that the sequence described here may be a base sequence or a root sequence of the sequence, or a cyclic shift of the base sequence or a cyclic shift of the root sequence.

Optionally, an initialization sequence of a scrambling sequence may be determined by at least one of the following parameters: a discovery area ID, a cell ID, a cycle index, a scrambling ID, an ID of the first UE, a resource index and an ID of a sequence of the sequence portion.

The second communication element 66 is at least configured to send the device discovery signal in the device discovery resource.

In one embodiment, the second UE 6 may detect the device discovery signal to discover the first UE.

### Embodiment 2

In one embodiment, a method for sending a device discovery signal is provided. The method can be implemented by means of the apparatus for sending a device discovery signal in Embodiment 1.

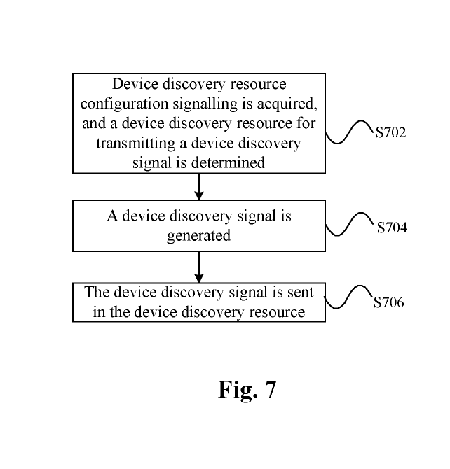

FIG. 7 is a flowchart of a method for sending a device discovery signal according to an embodiment of the present disclosure. As shown in FIG. 7, the method mainly includes that: Step S702: a UE acquires a device discovery resource configuration message, and determines, according to the device discovery resource configuration message, a device discovery resource for transmitting a device discovery signal; Step S704: the UE generates a device discovery signal; and Step S706: the UE sends the device discovery signal in the device discovery resource. It is important to note that the sequence of some steps is probably adjusted. For example, Step S702 and Step S704 may be reversed.

In one embodiment, the device discovery signal may at least include a message portion and a sequence portion, wherein the message portion is used for bearing information interacted between UEs in a device discovery process of D2D communication, and the sequence portion is used for implementing demodulation of the device discovery signal or synchronization in the device discovery process.

Optionally, a baseband signal of a physical channel corresponding to the message portion may be generated in accordance with the following steps: scrambling, modulation mapper, transform precoder, RE mapper and SC-FDMA signal generation. The sequence portion may be defined as one of: a ZC sequence, a QPSK modulation symbol sequence and an m-sequence. It is important to note that the sequence described here may be a base sequence or a root sequence of the sequence, or a cyclic shift of the base sequence or a cyclic shift of the root sequence.

Optionally, the scrambling refers to performing exclusive-or operation (XOR) on a bit content of the message portion and a scrambling sequence of which a length is equal to the number of bits in the bit content transmitted by the message portion. An initialization sequence of the scrambling sequence may be determined by at least one of the following parameters: a discovery area ID, a cell ID, a cycle index, a scrambling ID, a UE ID, a resource index and an ID of a sequence of the sequence portion.

Optionally, the discovery area ID is used for indicating one pre-determined discovery area. One discovery area may at least include one cell. Alternatively, one discovery area may be an area formed by a plurality of cells having the same discovery resource configuration, or an area determined in accordance with other rules. For example, one TA or cells having a same frequency point in one TA serves as one discovery area; or, one or more cells covered by the same macro eNB or cells having a same frequency point in the cells serve as one discovery area; or, one macro eNB cell and affiliated small cells serve as one discovery area, or cells having a same frequency point among these cells serve as one discovery area; or, one MBSFN area serves as one discovery area. Alternatively, the discovery area may be determined by means of other rules.

Optionally, the discovery area ID may be indicated from the network side device to the UE, and is, for example, carried in configuration signalling sent by the network side device.

Optionally, in an LTE system, the cell ID may be a Physical Cell ID (PCID).

Optionally, the cycle index represents a cycle serial number of the discovery resource. For example, if discovery resources of N cycles can be configured in a single discovery resource configuration, the cycle serial number of the discovery resource is 0 to N−1. Alternatively, the cycle index represents a cycle index for sending the discovery signal. For example, in the discovery resources configured in a single discovery resource configuration, the sending cycle index of the discovery signal is used for representing the number of times for sending the discovery signal by the UE. For example, when the discovery signal is sent for the first time, a parameter value is set to 0, when the discovery signal is sent for the second time, the parameter value is set to 1, and so on.

Optionally, the scrambling ID may be determined in one of the following manners: indication from control signalling sent by a network side; random selection conducted by the UE; and calculation (implicit indication) conducted by the UE in accordance with an appointed rule. The scrambling ID is used for distinguishing different scrambles. For example, when different UEs send discovery signals, scrambling identities may be different, so that when the discovery signals are sent in the same resource, the effect of interference randomization between the discovery signals sent by different UEs can be achieved via different scrambles.

In one embodiment, the step that the scrambling ID is indicated by the control signalling sent by the network side includes that: the network side device allocates the scrambling ID to the UE. For example, when the network side authorizes the UE to send the discovery signal, the network side indicates a scrambling ID for initializing the scrambling sequence to the UE. In an exemplary embodiment, the allocated scrambling ID is valued from a pre-defined scrambling ID set.

In one embodiment, the step that the scrambling ID is randomly selected by the UE includes that: an available scrambling ID set is appointed. For example, the appointed set includes integers 0 to B, B being an integer more than 0. When the UE initializes the scrambling sequence, a scrambling ID is randomly selected from the set as a scrambling ID of the scrambling sequence of the UE.

The scrambling ID may be implicitly indicated. For example, the scrambling ID may correspond to a sequence in the discovery signal. For example, a sequence set includes C different sequences, wherein C is an integer more than 0, and each sequence corresponds to one scrambling ID. For example, when the sequence is a ZC sequence or a QPSK modulation symbol sequence, each root sequence or base sequence in the set corresponds to one scrambling ID, or there is only one available root sequence or base sequence of the UE, and each available cyclic shift of the root sequence or base sequence corresponds to one scrambling ID.

Optionally, when the UE repeatedly sends the discovery signal, the scrambling identities may be identical or different. When the scrambling identities are identical, after the UE determines the scrambling identities in accordance with the above manners, the scrambling identities are used every time the discovery signal is sent. When the scrambling identities are different, every time the discovery signal is sent, the UE determines the scrambling identities in accordance with the above manners.

Optionally, the UE ID may include one of: an RNTI or information obtained by calculation according to the RNTI (for example, some fields in the RNTI); an IMSI or information obtained by calculation according to the IMSI (for example, some fields in the IMSI); a TMSI or information obtained by calculation according to the TMSI (for example, some fields in the TMSI); and a ProSe ID or a D2D communication ID (D2D ID).

Optionally, the resource index includes a time domain resource index and/or a frequency domain resource index. The frequency domain resource index is determined according to a frequency domain resource position of the device discovery signal. For example, it is found that there are N RB pairs for transmitting discovery signals, if the transmission bandwidth of each discovery signal in a frequency domain is 1 RB, the frequency domain resource index is 0 to N−1, and if the transmission bandwidth of each discovery signal in a frequency domain is 2 RBs, the frequency domain resource index is 0 to N/2−1. The time domain resource index is determined according to a time domain resource position of the device discovery signal. A time domain position is represented by serial numbers of sub-frames for sending the discovery signal in a radio frame (for example, the sub-frames may be numbered as 0-9 in accordance with an LTE specification); or the time domain position is represented by serial numbers of sub-frames for sending the discovery signal within a discovery resource cycle. If there are M discovery sub-frames, configured within one discovery resource cycle, for transmitting the discovery signal, a serial number of the time domain resource index is 0 to M−1, corresponding to the M discovery sub-frames.

Optionally, the ID of the sequence may be determined by a sequence index of the root sequence or the base sequence and/or a cyclic shift value of the root sequence or a cyclic shift value of the base sequence.

Optionally, the cyclic shift value may be obtained in one of the following manners: indication from control signalling sent by the network side; calculation conducted by the UE in accordance with an appointed rule; and random selection conducted by the UE from a pre-determined cyclic shift value set.

Optionally, the modulation mapper is used for modulating a bit sequence borne in the discovery signal to generate a constellation modulation symbol. In an exemplary embodiment, the modulation of the discovery signal only adopts QPSK modulation.

Furthermore, the RE mapper adopts a method for mapping first at a time domain and then at a frequency domain.

Optionally, in the embodiment of the present disclosure, the scrambling sequence has different initialization parameters in a synchronous network deployment and a non-synchronous network deployment. For example, in the synchronous network deployment, the initialization parameter of the scrambling sequence includes a discovery area ID, excluding a cell ID; while in the non-synchronous network deployment, the initialization parameter of the scrambling sequence includes a cell ID.

Furthermore, the transform precoder manner and the SC-FDMA signal generation manner may refer to corresponding processing of an uplink of a 3GPP LTE system, and are not elaborated here.

### Embodiment 3

A generation manner of a scrambling sequence of a device discovery signal is described in the embodiment.

In one implementation mode of the embodiment, the scrambling sequence adopts a pseudorandom sequence generated by a scrambling sequence generator defined by a 3GPP LTE system. The pseudorandom scrambling sequence is specifically generated with reference to a 3GPP LTE 36.211 protocol, and therefore is not elaborated here.

Optionally, an initialization sequence of the scrambling sequence may be determined by at least one of the following parameters: a discovery area ID, a cell ID, a cycle index, a scrambling ID, a UE ID, a resource index and an ID of a sequence included in the device discovery signal.

For example, an initialization mode of the scrambling sequence is cᵢₙᵢₜ=nₛₗₒₜ·2^{k2}+p·2^{k1}+N_{ID}^{cell} where N_{ID}^{cell} is a physical cell ID, p is a cycle index, and nₛₗₒₜ is a time domain resource index. That is, the scrambling sequence is initialized on the basis of the three parameters. The time domain resource index nₛₗₒₜ represents a serial number of a sub-frame for transmitting a discovery signal in a radio frame. Namely, └nₛ/2┘ (ns is a slot serial number, valued from 0 to 19) can also represent a serial number of a sub-frame for transmitting a discovery signal within a discovery resource cycle. If there are A sub-frames for device discovery within one discovery cycle, the serial numbers of the A sub-frames are 0 to A-1, corresponding to a time domain resource index value during the initialization of the scrambling sequence in the sub-frame for transmitting the discovery signal.

The values of k1 and k2 are positive integers. For example, when the length of N_{ID}^{cell} is 9 bits, k1 may be equal to or greater than 9, and k2 may be equal to or greater than k1+9.

For example, the initialization mode of the scrambling sequence may be cᵢₙᵢₜ=nₛₗₒₜ·2^{k1}+n_{SCID}, where nₛₗₒₜ is a time domain resource index as described above, and n_{SCID} represents a scrambling ID.

For example, the initialization mode of the scrambling sequence may be cᵢₙᵢₜ=nₛₗₒₜ·2^{k2}+N_{ID}^{DA}·2^{k1}+n_{SCID}, where N_{ID}^{DA} is a discovery area ID, and other parameters are the same as those mentioned above, thus will not be repeated.

For example, the initialization mode of the scrambling sequence may be cᵢₙᵢₜ=N_{ID}^{UE}·2^{k2}+nₛₗₒₜ·2^{k1}+N_{ID}^{cell}, where N_{ID}^{UE} is a UE ID, and the definitions of other parameters are the same as those mentioned above, thus will not be repeated.

For example, the initialization mode of the scrambling sequence may be cᵢₙᵢₜ=nₛₗₒₜ·2^{k1}+N_{ID}^{cell}, where each parameter definition is the same as that mentioned above, thus will not be repeated.

For example, the initialization mode of the scrambling sequence may be cᵢₙᵢₜ=n_{RB}·2^{k2}+nₛₗₒₜ·2^{k1}+N_{ID}^{cell}, where n_{RB} is a frequency domain index of a discovery resource as described above, and other parameters are the same as those mentioned above, thus will not be repeated.

It is important to note that the initialization of the scrambling sequence is described by taking some parameters as examples, rather than limitations to the initialization of the scrambling sequence. In actual discovery, the illustrated parameters may be randomly combined, and the arrangement order of parameters in an initialization formula may not be limited to the examples.

### Embodiment 4

In one implementation mode of the embodiment, a scrambling sequence adopts a pseudorandom sequence generated by a scrambling sequence generator defined by a 3GPP LTE system. The pseudorandom scrambling sequence is specifically generated with reference to a 3GPP LTE 36.211 protocol and thus will not be elaborated here.

In one implementation mode of the embodiment, initialization parameters of the scrambling sequence are different for a synchronous network deployment and a non-synchronous network deployment.

In one implementation mode of the embodiment, for the synchronous network deployment, the initialization parameter of the scrambling sequence includes a discovery area ID and excludes a cell ID. If UEs falling within different cells are located in an identical discovery area, the UEs have the same scrambling sequence initialization parameter, such that the UEs can directly detect discovery signals sent by the UEs in the same discovery area, not needing to know IDs of the cells where the UEs are located.

In one implementation mode of the embodiment, for the non-synchronous network deployment, the initialization parameter of the scrambling sequence includes a physical cell ID. If physical cell IDs of UEs falling within different cells are different, scrambling sequences are different. Thus, in a non-synchronous network, the effect of interference randomization between the discovery signals of different cells can be achieved.

### Embodiment 5

### Regarding a Sequence Generation Manner

In the embodiment, a generation manner of a sequence of a sequence portion in a device discovery signal is described.

In one implementation mode of the embodiment, a device discovery signal sent by a UE includes a sequence portion. The sequence portion may be a ZC sequence such as a base sequence or a root sequence of the ZC sequence, or a cyclic shift of the base sequence or a cyclic shift of the root sequence. The sequence portion may be a QPSK modulation symbol sequence such as a QPSK modulation symbol base sequence or a cyclic shift of the QPSK modulation symbol base sequence. The sequence portion may be an m-sequence.

For example, the sequence portion is the QPSK modulation symbol sequence, which can be generated with reference to a sequence generation manner when the length of a base sequence of an uplink reference signal sequence of an LTE system is less than 36, thus will not be repeated.

For example, the sequence portion is the ZC sequence, which can be generated with reference to a sequence generation manner when the length of a base sequence of an uplink reference signal sequence of an LTE system is equal to or greater than 36 or with reference to a sequence generation manner of a PSS of the LTE system or can be generated in accordance with a ZC sequence generation manner of the uplink reference signal sequence of the LTE system when the length of the sequence is less than 36.

For example, the sequence portion may be the m-sequence, which can be generated with reference to a sequence generation manner of an SSS of the LTE system.

The sequence of the sequence portion may be used for demodulating a message portion in a discovery signal and/or used for performing synchronization, the synchronization referring to synchronization between a discovery signal receiver and a discovery signal transmitter by detecting the sequence.

Optionally, in a cell or a discovery area, an identical base sequence may be configured to generate the sequence.

Optionally, the discovery signal sent by a UE may be a cyclic shift of the base sequence or a cyclic shift of the root sequence, the cyclic shift is defined as r(n)=e^{jαn}r̅(n), 0≦n<N (0≦n<N), where r̅(n) is a base sequence or a root sequence, r(n) is a cyclically shifted sequence, N is a sequence length, and α is a cyclic shift value: α=2πn_{cs}/K, where K may be the number of cyclic shifts supported by a system, n_{cs} is an integer of 0˜K−1, and multiple manners of acquiring n_{cs} are described below.

n_{cs} may be indicated by control signalling sent by a network side node. For example, a UE determines the value of n_{cs} according to specific signalling sent by a base station.

Or, the UE calculates the value of n_{cs} according to an appointed rule. For example, according to a UE_ID, the UE can calculate the cyclic shift value by the following formula: n_{sc}=mod(UE_ID, K), where the UE_ID can be determined in a following manner: an RNTI or calculation according to the RNTI (for example, some fields in the RNTI); an IMSI or calculation according to the IMSI (for example, some fields in the IMSI); and a TMSI or calculation according to the TMSI (for example, some fields in the TMSI). In the example, in addition to UE_ID, parameters for calculating the value of n_{cs} may be other known parameters of the UE (for example, a physical cell ID, a discovery resource cycle index, a discovery sub-frame index and the like), which will not be elaborated here.

Or, the appointed rule refers to calculating the cyclic shift value in a pseudorandom manner. When the cyclic shift value is calculated in the pseudorandom manner, a pseudorandom sequence is calculated on the basis of a specific rule firstly. The pseudorandom sequence may be a scrambling sequence for scrambling described in the embodiment or a pseudorandom sequence generated by adopting a similar scrambling sequence generation manner in the embodiment. Secondly, the cyclic shift value is determined according to the pseudorandom sequence and the specific rule. The specific rule may refer to modular operation. For example, the above K is subjected to modular operation after the pseudorandom sequence is converted into a decimal sequence. No repeated descriptions will be made.

Or, the UE randomly selects the value of n_{sc}.

Or, the value of n_{cs} may be determined by combination of the manners. For example, the value of n_{cs} is determined cooperatively according to the parameter which is sent by the network side node for determining the value of n_{cs} and one or more parameters known to the UE. For example, n_{cs}=mod(Para+UE_ID,K), where UE_ID represents a UE ID or other parameters known to the UE (for example, a physical cell ID, a discovery resource cycle index, a discovery sub-frame index and the like), and Para is a parameter which is sent by the network side node for determining the value of n_{cs}. Para may be cell-specific, namely an identical value shared in a cell, and in such a condition, Para may be sent via broadcast signalling; and Para may be discovery area-specific, namely an identical value shared in a discovery area.

From the above descriptions, it can be seen that, by means of the technical solutions provided by the embodiments of the present disclosure, the problems about signal processing and sending of a device discovery signal during D2D communication is solved, interferences between different discovery signals are effectively avoided, and the universality and efficiency of a device discovery method and apparatus are improved.

Obviously, those skilled in the art should understand that all components or all steps in the present disclosure can be realized by using a general calculation apparatus, can be centralized on a single calculation apparatus or can be distributed on a network composed of a plurality of calculation apparatuses. Optionally, they can be realized by using executable program codes of the calculation apparatuses. Thus, they can be stored in a storage apparatus and executed by the calculation apparatuses, the shown or described steps can be executed in a sequence different from this sequence under certain conditions, or they are manufactured into each integrated circuit component respectively, or a plurality of components or steps therein are manufactured into a single integrated circuit component. Thus, the present disclosure is not limited to a combination of any specific hardware and software.

The above is only the preferred embodiments of the present disclosure, and is not intended to limit the present disclosure. There can be various modifications and variations in the present disclosure for those skilled in the art. Any modifications, equivalent replacements, improvements and the like within the principle of the present disclosure shall fall within the protection scope defined by the appended claims of the present disclosure.

### INDUSTRIAL APPLICABILITY

On the basis of the technical solutions provided by the embodiments of the present disclosure, a UE acquires a device discovery resource for transmitting a device discovery signal from a device discovery resource configuration message, and transmits the device discovery signal on the device discovery resource, thereby solving the problems about signal processing and sending of the device discovery signal during D2D communication, effectively avoiding interferences between discovery signals sent by different UEs and improving the universality and efficiency of a device discovery method and apparatus.

1. A method for sending a device discovery signal, comprising:
receiving, by a first User Equipment (UE), a device discovery resource configuration message, and determining, according to the device discovery resource configuration message, a device discovery resource for transmitting a device discovery signal;
generating, by the first UE, a device discovery signal, wherein the device discovery signal comprises a message portion and a sequence portion, the message portion is used for bearing information about the first UE which needs to be interacted in a device discovery process of Device-to-Device (D2D) communication, and the sequence portion is used for implementing demodulation of the device discovery signal or synchronization in the device discovery process; and
sending, by the first UE, the device discovery signal in the device discovery resource.

2. The method as claimed in claim 1, wherein
the sequence portion comprises at least one of: a Zadoff-Chu (ZC) sequence, a Quadrature Phase Shift Keying (QPSK) modulation symbol sequence and an m-sequence; and/or,
generating a baseband signal of a physical channel corresponding to the message portion comprises:
scrambling a bit content of the message portion by using a scrambling sequence of which a length is equal to the number of bits in the bit content transmitted by the message portion;
performing modulation mapper on the scrambled message portion;
performing transform precoder on a modulation symbol sequence obtained by the modulation mapper;
performing Resource Element (RE) mapper on a sequence obtained by the transform precoder; and
generating a Single Carrier-Frequency Division Multiplexing Access (SC-FDMA) signal based on a signal obtained by the RE mapper.

3. The method as claimed in claim 2, wherein an initialization sequence of the scrambling sequence is determined by at least one of the following parameters:
a discovery area Identity (ID), a cell ID, a cycle index, a scrambling ID, an ID of the first UE, a resource index and an ID of a sequence of the sequence portion.

4. The method as claimed in claim 3, wherein the cycle index comprises: a cycle index of the device discovery resource or a cycle index for sending the device discovery signal.

5. The method as claimed in claim 3, wherein the discovery area ID is used for indicating one pre-determined discovery area, the discovery area comprising one of: a plurality of cells having a same device discovery resource configuration; one Track Area (TA) or cells having a same frequency point in one TA; one or multiple cells covered by a base station or cells having a same frequency point in the cells; one macro base station cell and affiliated small cells; cells having a same frequency point in one macro base station cell and affiliated small cells; and one Multicast Broadcast Single Frequency Network (MBSFN) area.

6. The method as claimed in claim 3, wherein a determination manner of the scrambling ID comprises one of:
indication from control signalling sent by a network side;
calculation conducted by the first UE in accordance with an appointed rule; and
random selection conducted by the first UE from a pre-determined scrambling ID set.

7. The method as claimed in claim 3, wherein the ID of the first UE comprises one of:
a Radio Network Temporary Indicator (RNTI) or information obtained by calculation according to the RNTI;
an International Mobile Subscriber Identity (IMSI) or information obtained by calculation according to the IMSI;
a Temporary Mobile Subscriber Identity (TMSI) or information obtained by calculation according to the TMSI; and
a Proximity Service (ProSe) ID or a D2D communication ID.

8. The method as claimed in claim 3, wherein the resource index comprises: a time domain resource index and/or a frequency domain resource index, wherein
the frequency domain resource index is determined according to a frequency domain resource position of the device discovery signal,
the time domain resource index is determined according to a time domain resource position of the device discovery signal, and a time domain position is indicated by an index of a sub-frame for sending the device discovery signal in a radio frame or indicated by an index of a sub-frame for sending the device discovery signal within a discovery resource cycle.

9. The method as claimed in claim 3, wherein the ID of the sequence is determined by one of:
a sequence index of the sequence;
a cyclic shift value of the sequence; and
the sequence index of the sequence and the cyclic shift value of the sequence.

10. The method as claimed in claim 3, wherein an initialization parameter of the scrambling sequence in a synchronous network deployment is different from an initialization parameter of the scrambling sequence in a non-synchronous network deployment.

11. The method as claimed in claim 1, wherein the sequence of the sequence portion is a cyclic shift of a base sequence or a cyclic shift of a root sequence; and a cyclic shift value is determined by one of:
indication from control signalling sent by the network side;
calculation conducted by the first UE in accordance with an appointed rule; and
random selection conducted by the first UE from a pre-determined cyclic shift value set.

12. The method as claimed in claim 1, wherein after the first UE sends the device discovery signal in the device discovery resource, the method further comprises:
detecting, by a second UE, the device discovery signal, and discovering the first UE through the device discovery signal.

13. An apparatus for sending a device discovery signal, comprising:
a first communication element, configured to receive a device discovery resource configuration message, and determine, according to the device discovery resource configuration message, a device discovery resource for transmitting a device discovery signal;
a baseband processing element, configured to generate the device discovery signal, wherein the device discovery signal comprises a message portion and a sequence portion, the message portion is used for bearing information about a first UE which needs to be interacted in a device discovery process of Device-to-Device (D2D) communication, and the sequence portion is used for implementing demodulation of the device discovery signal or synchronization in the device discovery process; and
a second communication element, configured to send the device discovery signal in the device discovery resource.

14. The apparatus as claimed in claim 13, wherein the baseband processing element is configured to generate a baseband signal of a physical channel corresponding to the message portion in a following manner:
scrambling a bit content of the message portion by using a scrambling sequence of which a length is equal to the number of bits in the bit content transmitted by the message portion;
performing modulation mapper on the scrambled message portion;
performing transform precoder on a modulation symbol sequence obtained by the modulation mapper;
performing Resource Element (RE) mapper on a sequence obtained by the transform precoder; and
generating a Single Carrier-Frequency Division Multiplexing Access (SC-FDMA) signal based on a signal obtained by the RE mapper.

15. The apparatus as claimed in claim 14, wherein an initialization sequence of the scrambling sequence is determined by at least one of the following parameters: a discovery area Identity (ID), a cell ID, a cycle index, a scrambling ID, an ID of the first UE, a resource index and an ID of a sequence of the sequence portion.

16. A wireless communication system, comprising: a network side device, a first User Equipment (UE) and a second UE, wherein
the network side device comprises:
a configuration component, configured to configure a device discovery resource for Device-to-Device (D2D) communication; and
a sending component, configured to send a device discovery resource configuration message, wherein the device discovery resource configuration message carries the device discovery resource;
the first UE comprises:
a first communication element, configured to receive the device discovery resource configuration message, and determine, according to the device discovery resource configuration message, the device discovery resource for transmitting a device discovery signal;
a baseband processing element, configured to generate the device discovery signal; and
a second communication element, configured to send the device discovery signal in the device discovery resource; and
the second UE is configured to detect the device discovery signal and discover the first UE through the device discovery signal.

17. The system as claimed in claim 16, wherein the network side device comprises at least one of: a base station, a network access device other than the base station, an upper network node, a server or a network element providing service for the D2D communication, a network element temporarily deployed in a no coverage scenario, and a UE serving as a cluster head or a primary UE.

18. The method as claimed in claim 2, wherein after the first UE sends the device discovery signal in the device discovery resource, the method further comprises:
detecting, by a second UE, the device discovery signal, and discovering the first UE through the device discovery signal.

19. The method as claimed in claim 3, wherein after the first UE sends the device discovery signal in the device discovery resource, the method further comprises:
detecting, by a second UE, the device discovery signal, and discovering the first UE through the device discovery signal.

20. The method as claimed in claim 11, wherein after the first UE sends the device discovery signal in the device discovery resource, the method further comprises:
detecting, by a second UE, the device discovery signal, and discovering the first UE through the device discovery signal.
